(19) United States
(12) Patent Application Publication
(10) Pub. No.: US 2008/0074240 A1
(43) Pub. Date: Mar. 27, 2008

(54) SYSTEM AND METHOD FOR CONNECTING EMPLOYEE STATUS VIA OFFICE LIGHT SWITCH

(76) Inventors: JEFFREY ALLEN JONES, Round Rock, TX (US); DOUGLAS SCOTT ROTHERT, Austin, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(21) Appl. No.: 11/533,173

(22) Filed: Sep. 19, 2006

(51) Int. Cl. G08B 9/00; G08B 29/00; G06F 3/00; G06F 15/16

(52) U.S. Cl. 340/286.02; 340/506; 709/206; 710/15

(57) ABSTRACT

A system, method, and program product that generates a person's status value at a status indicator device, and that replicates the status to at least one additional status indicator device. The status indicator device is selected from one or more status indicator devices, wherein at least one of the status indicator devices is a light switch and wherein the status value is set based upon a setting of the light switch. Other embodiments are also disclosed.

### BACKGROUND OF THE INVENTION

1. Technical Field

The present invention relates in general to a system and method for indicating status of a person. In particular, the present invention relates to a system and method that indicates status of a person at multiple status indicating devices based on the state of a single status indicating device such as an office light switch.

2. Description of the Related Art

Historically, status of a person, i.e., whether the person is on vacation, out for lunch, at their desk, at home, etc., is kept in an uncoordinated manner in which separate status indicating devices may or may not be set to indicate the status of the person.

For example, when an employee will be out of the office, the employee may or may not change separate status indicating devices such as their outgoing email or voice mail to indicate to others that they will be out of the office. Specifically, although an employee may set one status indicating device to indicate that they will be out of the office on vacation, the employee, either intentionally or inadvertently, may not set other status indicating devices to indicate the same out of office status. In other words, although the employee sets an outgoing email message to indicate that they will be out of the office on vacation, because the employee may have forgotten to set an outgoing voice mail message that indicates a similar out of office message, someone attempting to contact the employee while the employee is out may be confused as to the actual status of the employee. The person attempting to contact the employee may receive an out of office email response message from the employee that states that the employee is out of the office on vacation, while also receiving a voice mail message that states that the employee is in the office and available but currently not able to answer the phone.

This confusion could result in lost opportunities for an employer, or the confusion could leave a negative impression that tarnishes an employer's reputation with the customer.

Further, even if upon leaving their office an employee remembers to set the correct employee status at all status indicating devices, the employee may forget to properly update their status when the employee returns to their office. This type of error could result in a more persistent problem because the status at erroneously reporting status indicating devices may not be checked again until the employee leaves the office for something else such as a vacation.

Many other problems and disadvantages of the prior art will become apparent to one skilled in the art after comparing such prior art with the present invention as described herein.

### SUMMARY

It has been discovered that the aforementioned challenges are resolved using a system, method, and program product that generates a person's status value at a status indicator device. The system further replicates the status to other status indicator devices. One example of a status indicator device is a light switch. In this example, the status value is set based upon the setting of the light switch (e.g., “on” indicating that the person is present, “off” indicating that the person is absent).

The status value corresponds to actions that are taken at the status indicator device. The actions that are performed are retrieved from a configuration data store. The actions stored in the configuration data store pertain to the user of the system.

In one embodiment, the user may choose the action of notifying others when the status value changes to a particular state. In addition to the light switch, other examples of status indicator devices that generate status values include calendar entries, outgoing telephone messages, door locks, window coverings, email messages, motion sensors, or other similar device or software. Other actions, other than notifying others, can also take place when the status value changes. For example, actions that can take place include changing an email setting, changing a voice mail setting, shutting down devices, adjusting an HVAC system, activating a surveillance system, and so forth.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a flowchart of an embodiment of the present invention where steps are shown for checking control elements and taking actions of a selected control element;

FIG. 2 is a flowchart showing a detailed embodiment of actions that may be taken based on an action identifier of a selected control element;

FIG. 3 is a flowchart showing further actions that may be taken based on an action identifier of a selected control element;

FIG. 4 is a flowchart showing still further actions that may be taken based on an action identifier of a selected control element;

FIG. 5 is a flowchart showing additional actions that may be taken based on an action identifier of a selected control element;

FIG. 6 is a flowchart showing a detailed embodiment for notifying others according to user preferences; and

FIG. 7 is a block diagram of an information handling system in which the processes described herein may be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

In general, one embodiment of the invention pertains to indicating status of a user by coordinating a status value for the user among one or more status indicator devices associated with the user. Of note, in the following detailed description of embodiments of the invention, status indicator devices are also referred to as “control elements.”

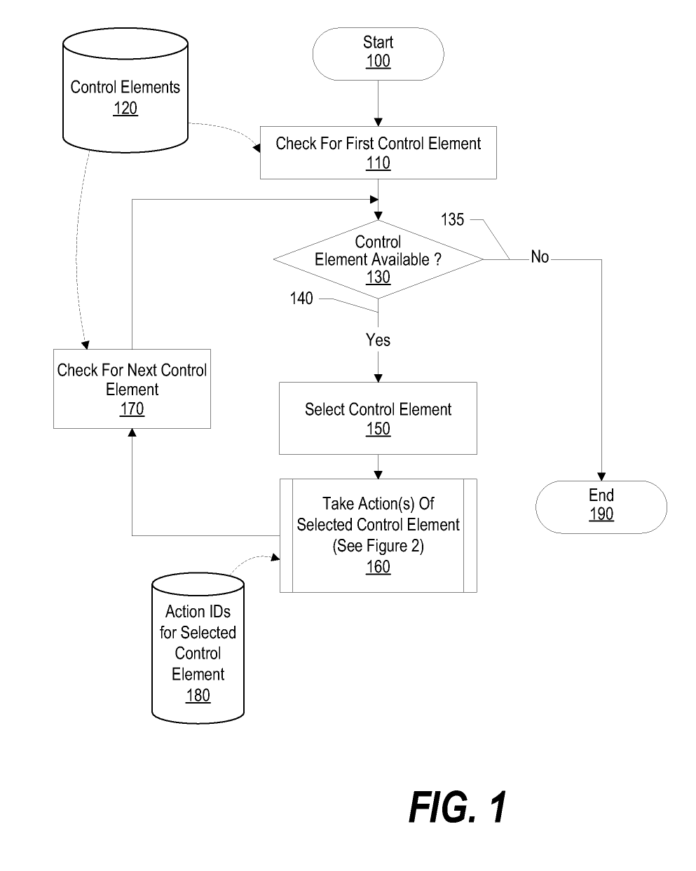

FIG. 1 is a flowchart of an embodiment of the present invention where steps are shown for checking control elements and taking actions of a selected control element. Checking of control elements commences at step 100, whereupon, at step 110, processing checks for a first control element from control elements data store 120. A determination is made as to whether the first control element is available for further processing (decision 130). If the first control element is not available for further processing, decision 130 branches to “no” branch 135 and processing ends at step 190. Otherwise, processing branches to “yes” branch 140 and the first control element is selected at step 150. Processing of the selected first control element begins at predefined processing 160.

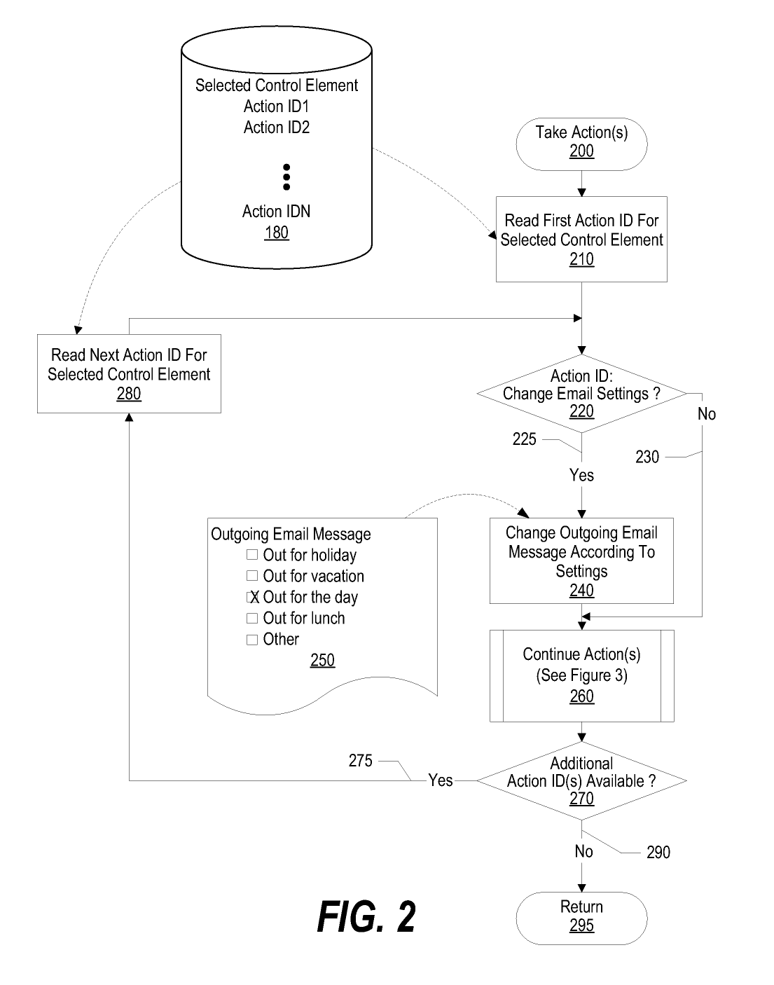

Predefined processing 160 generally depicts taking the coordinating actions as indicated by the selected control element. Further details of these actions are described with respect to FIG. 2. Actions for a control element are determined by action identifiers that are stored with relation to the selected control element. The action identifiers are stored within configuration data store 180.

After taking the action or actions so indicated by the selected control element at predefined processing 160, processing continues and, at step 170, processing checks for the next control element from control elements 120, whereupon, processing loops back to decision 130. This looping continues until no more control elements are available from control elements 120.

Returning to decision 130, the determination is made as to whether another control element is available. If another control element is available, processing branches to “yes” branch 140 and the next control element is processed. Processing continues in this manner until no more control elements are available for processing, whereupon decision 130 branches to “no” branch 135 and processing ends at step 190.

Control elements 120 can take the form of a hardware device, a software program, or an embodiment containing both hardware and software elements. For example, control elements 120 can take the form of status indicator devices such as a calendar entry, a light switch, an outgoing telephone message, a door lock, a window covering, an email message, a motion sensor, and so forth. In certain embodiments, the status indicator devices are implemented in software, which include but are not limited to firmware devices, resident software devices, microcode devices, etc. Upon viewing the present disclosure, it will be appreciated that embodiments of control elements 120 also include a motion sensor that would detect the presence of a vehicle being parked in a particular location or a person entering a room or other monitored location.

FIG. 2 is a flowchart showing a detailed embodiment of actions that may be taken based on an action identifier of a selected control element. Processing commences at 200, whereupon, at step 210 a first action identifier is read from configuration data store 180. The first action identifier corresponds to the first action identifier of the selected control element, the control element having previously been selected during the processing shown in FIG. 1.

A determination is made as to whether the first action identifier pertains to changing an email setting (decision 220). If the first action identifier pertains to changing email settings for a person, decision 220 branches to “yes” branch 225, whereupon, an outgoing email message is changed at step 240 if required by the current email status.

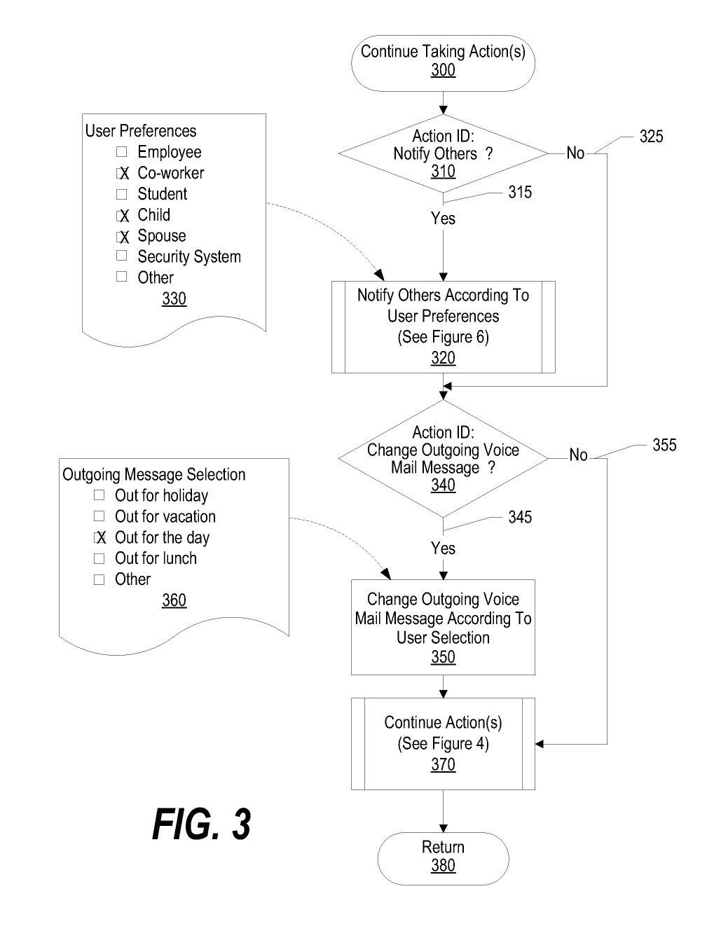

By reading outgoing email message settings 250, processing step 240 identifies the settings that the action identifier indicates for the outgoing email message. If the person or system has already changed the outgoing email message to correspond to the action identifier indications, then the outgoing email message is not changed. Otherwise, the outgoing email message is changed to match the action identifier indications before continuing to process actions for the selected action identifier at predefined process 260 (see FIG. 3 and corresponding text for processing details).

Returning to decision 220, if the selected action is not to change email settings, decision 220 branches to “no” branch 230 bypassing step 240 and actions are processed for the selected action identifier at predefined processing 260. In other words, no processing is performed regarding the change of email settings because the action identifier so indicates.

Upon completion of the processing at predefined processing 260, a determination is made as to whether additional action identifiers are available that correspond to the selected control element (decision 270). If an additional action identifier is available, decision 270 branches to “yes” branch 275, whereupon, at step 280, the next action identifier for the selected control element is read from configuration data store 180 and processing loops back to process the newly read action identifier. This looping continues until there are no more action identifiers available for the selected control element, at which time decision 270 branches to “no” branch 290 and processing returns to the calling routine at 295.

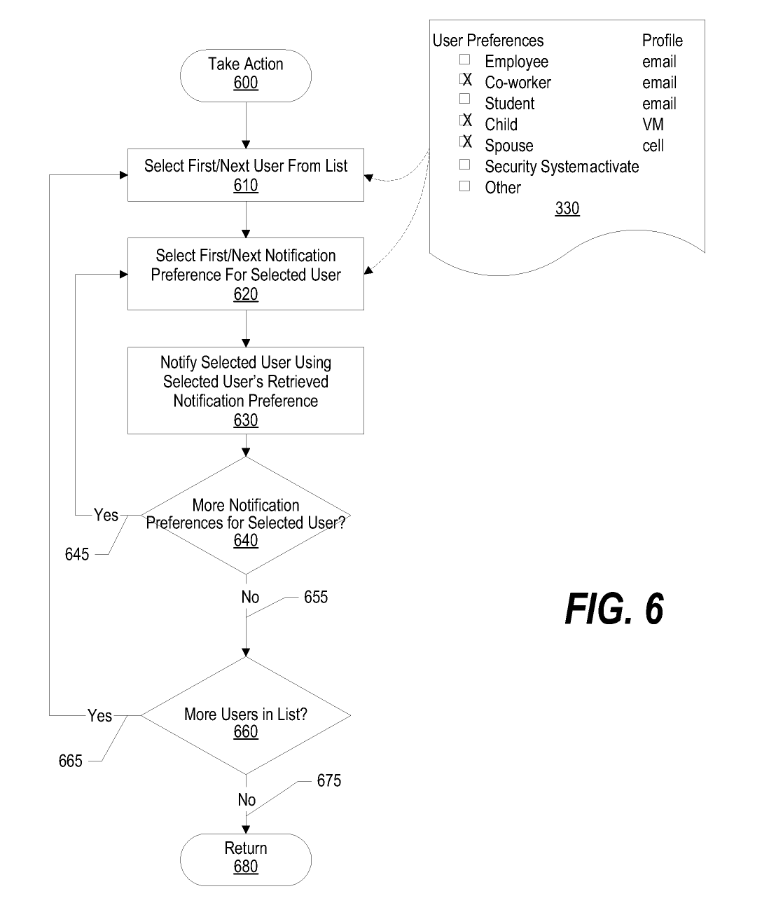

FIG. 3 is a flowchart showing further actions that may be taken based on an action identifier of a selected control element. Processing commences at 300, whereupon a determination is made as to whether the action identifier pertains to notifying others of a person's status (decision 310). If the action identifier indicates that others are to be notified of the person's status, decision 310 branches to “yes” branch 315, whereupon others are notified of the person's status based upon user notification preferences 330 (predefined process 320, see FIG. 6 and related description for more details). On the other hand, if the action identifier indicates that others are not to be notified, decision 310 branches to “no” branch 325 bypassing predefined process 320.

In general, predefined process 320 reads the selected user preferences 330 corresponding to the action identifier to identify those users which the person would like to notify when an action identifier indicating to notify others is encountered.

A determination is made as to whether the action identifier pertains to changing an outgoing voice mail message (decision 340). If the action identifier pertains to changing an outgoing voice mail message, decision 340 branches to “yes” branch 345, whereupon, an outgoing voice mail message is changed at step 350. This change is based upon current outgoing message selection 360 that corresponds to the action identifier. On the other hand, if the action identifier does not pertain to changing an outgoing voice mail message, decision 340 branches to “no” branch 355 bypassing step 350.

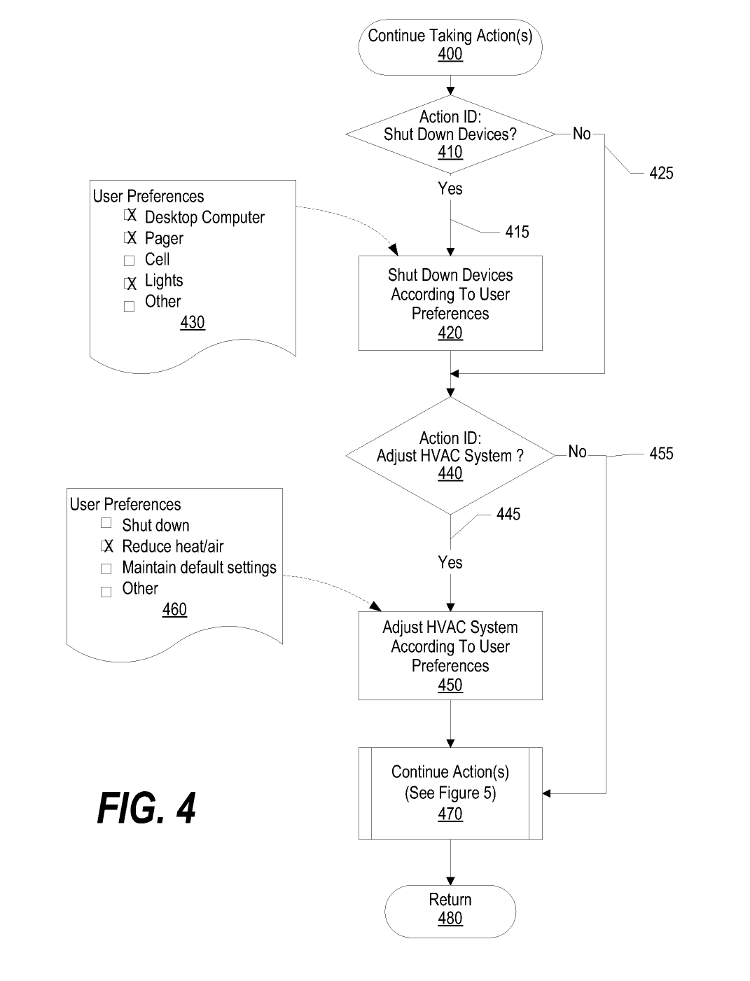

Processing of other actions is shown at predefined process 370 (see FIG. 4 and corresponding text for processing details of other actions). Processing then returns to the calling routine at 380.

FIG. 4 is a flowchart showing still further actions that may be taken based on an action identifier of a selected control element. Processing commences at 400, whereupon a determination is made as to whether the action identifier pertains to shutting down devices (decision 410). If the action identifier indicates that devices are to be shut down, decision 410 branches to “yes” branch 415, whereupon, at step 420, devices are shut down according to user shutdown preferences 430. Examples of devices that may be shut down based upon the user's preferences include the user's computer, a pager, a mobile phone, lights, or other devices. On the other hand, if the action identifier indicates that devices are not to be shut down, decision 410 branches to “no” branch 425 bypassing step 420.

A determination is made as to whether the action identifier pertains to adjusting an HVAC system (decision 440). If the action identifier pertains to adjusting an HVAC system, decision 440 branches to “yes” branch 445, whereupon, an HVAC system is adjusted at step 450 according to user HVAC preferences 460. Examples of HVAC settings include shutting the system down, changing the temperature/airflow, and maintaining default settings. Returning to decision 440, if the action identifier indicates that the HVAC system is not to be adjusted, then decision 440 branches to “no” branch 455 bypassing step 450.

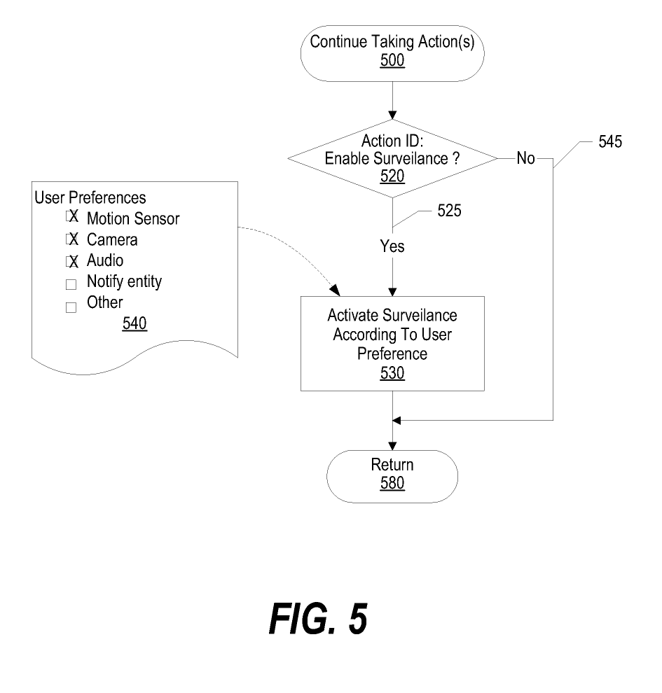

Processing of other actions is shown at predefined process 470 (see FIG. 5 and corresponding text for processing details of other actions). Processing then returns to the calling routine at 480.

FIG. 5 is a flowchart showing additional actions that may be taken based on an action identifier of a selected control element. Processing commences at 500, whereupon a determination is made as to whether the action identifier pertains to enabling surveillance processing (decision 520). If the action identifier indicates that surveillance processing is to be enabled, decision 520 branches to “yes” branch 525, whereupon, at step 530, surveillance devices are activated to perform surveillance according to user surveillance preferences 540. Examples of surveillance processing that can be performed include activating a motion sensor, activating a camera, activating (or disabling) an audio system, or activating another type of surveillance process. Returning to decision 520, if the action identifier indicates that surveillance is not to be enabled, then decision 520 branches to “no” branch 545 bypassing step 530. Processing then returns to the calling routine at 580.

FIG. 6 is a flowchart showing a detailed embodiment for notifying others according to user preferences. The notifying of FIG. 6 is performed in response to encountering an action identifier that indicates that processing should notify others of a person's status (see predefined process 320 in FIG. 3).

Processing commences at 600, whereupon, at step 610, a first user is selected from list of user notification preferences 330. The notification preferences includes at least one preferred method for notifying the selected user. This preferred notification method is read at step 620. At step 630, the selected user is notified according to the notification preference.

A determination is made as to whether additional notification preferences for the selected user are available (decision 640). If additional notification preferences are available, decision 640 branches to “yes” branch 645 and processing loops back to select the next notification preference for the selected user. This looping continues until there are no more notification preferences for the selected user, at which time decision 640 branches to “no” branch 655.

A determination is made as to whether there are more users to notify in user notification list 330 (decision 660). If there are more users to notify, decision 660 branches to “yes” branch 665 and processing loops back to select and process the next user from user notification list 330. This looping continues until all users from user notification list 330 have been processed, at which point decision 660 branches to “no” branch 675, whereupon processing returns at step 680.

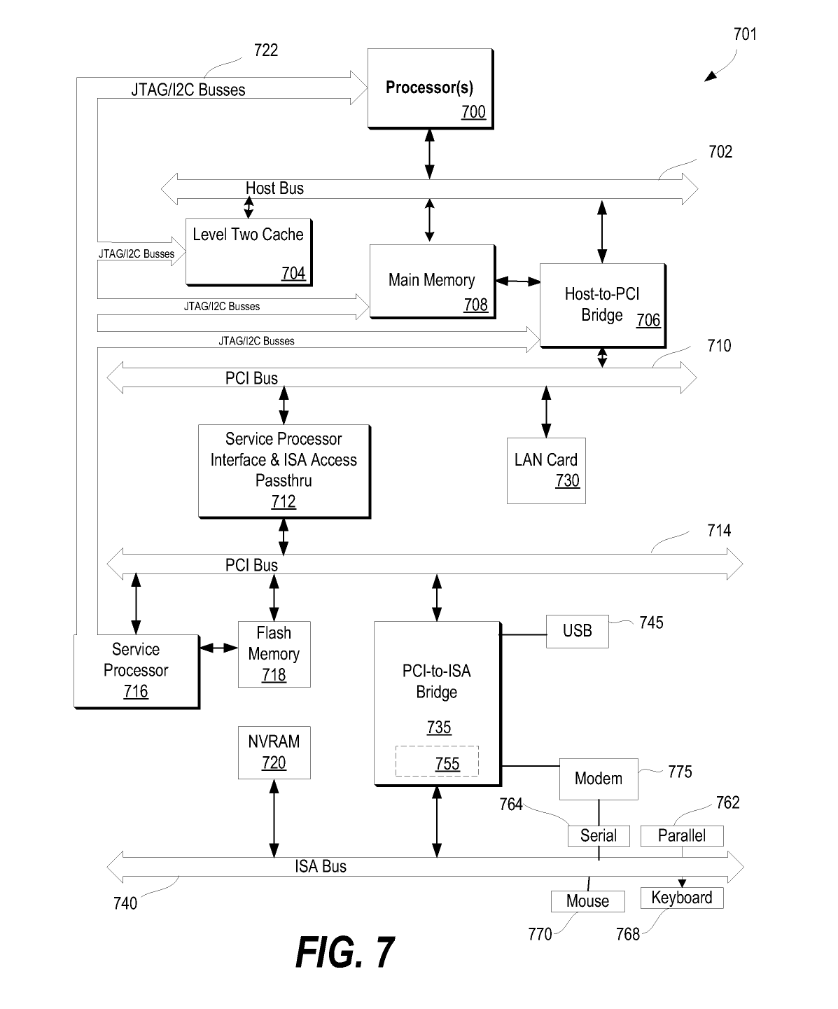

FIG. 7 illustrates information handling system 701 which is a simplified example of a computer system capable of performing the computing operations described herein. Computer system 701 includes processor 700 which is coupled to host bus 702. A level two (L2) cache memory 704 is also coupled to host bus 702. Host-to-PCI bridge 706 is coupled to main memory 708, includes cache memory and main memory control functions, and provides bus control to handle transfers among PCI bus 710, processor 700, L2 cache 704, main memory 708, and host bus 702. Main memory 708 is coupled to Host-to-PCI bridge 706 as well as host bus 702. Devices used solely by host processor(s) 700, such as LAN card 730, are coupled to PCI bus 710. Service Processor Interface and ISA Access Pass-through 712 provides an interface between PCI bus 710 and PCI bus 714. In this manner, PCI bus 714 is insulated from PCI bus 710. Devices, such as flash memory 718, are coupled to PCI bus 714. In one implementation, flash memory 718 includes BIOS code that incorporates the necessary processor executable code for a variety of low-level system functions and system boot functions.

PCI bus 714 provides an interface for a variety of devices that are shared by host processor(s) 700 and Service Processor 716 including, for example, flash memory 718. PCI-to-ISA bridge 735 provides bus control to handle transfers between PCI bus 714 and ISA bus 740, universal serial bus (USB) functionality 745, power management functionality 755, and can include other functional elements not shown, such as a real-time clock (RTC), DMA control, interrupt support, and system management bus support. Nonvolatile RAM 720 is attached to ISA Bus 740. Service Processor 716 includes JTAG and I2C busses 722 for communication with processor(s) 700 during initialization steps. JTAG/I2C busses 722 are also coupled to L2 cache 704, Host-to-PCI bridge 706, and main memory 708 providing a communications path between the processor, the Service Processor, the L2 cache, the Host-to-PCI bridge, and the main memory. Service Processor 716 also has access to system power resources for powering down information handling device 701.

Peripheral devices and input/output (I/O) devices can be attached to various interfaces (e.g., parallel interface 762, serial interface 764, keyboard interface 768, and mouse interface 770 coupled to ISA bus 740. Alternatively, many I/O devices can be accommodated by a super I/O controller (not shown) attached to ISA bus 740.

In order to attach computer system 701 to another computer system to copy files over a network, LAN card 730 is coupled to PCI bus 710. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the processes described herein, this computer system is simply one example of a computer system. Those skilled in the art will appreciate that many other computer system designs are capable of performing the processes described herein.

One of the preferred implementations of the invention is a software program, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be appreciated by those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method for indicating status of a user comprising:
generating a status value at a status indicator device selected from one or more status indicator devices, wherein at least one of the status indicator devices is a light switch and wherein the status value is set based upon a setting of the light switch;
replicating the status to at least one additional status indicator device;
retrieving, from a configuration data store, one or more actions that correspond to at least one of the status indicator devices, wherein the actions stored in the configuration data store are configured to the user and to one or more of the status indicator devices; and
performing the retrieved actions.

2. The method of claim 1 wherein the status value is selected from the group consisting of an out of office value, an on vacation value, an out on business value, an out for lunch value, an out with illness value, an in office value, and an in office but unavailable value.

3. The method of claim 1 further comprising notifying others of a status description that corresponds to the status value.

4. The method of claim 1 further comprising:
performing an action selected from the group consisting of changing an email setting, changing a voice mail setting, notifying others, shutting down devices, adjusting an HVAC system, and activating a surveillance system.

5. The method of claim 1 further comprising:
selecting the status indicator device from the group consisting of a calendar entry, an outgoing telephone message, a door lock, a window covering, an email message, and a motion sensor.

6. The method of claim 1 further comprising performing a sequence of actions corresponding to an action identifier associated with one of the status indicator devices.

7. The method of claim 1 further comprising responding to a trigger at one of the status indicator devices.

8. An information handling system comprising:
one or more processors;
a memory accessible by at least one of the processors;
a nonvolatile storage area accessible by at least one of the processors;
a network interface that connects the information handling system to a computer network, the network interface being accessible by at least one of the processors; and
a set of instructions stored in the memory, wherein at least one of the processors executes the set of instructions in order to perform actions of:
generating a status value at a status indicator device selected from one or more status indicator devices, wherein at least one of the status indicator devices is a light switch and wherein the status value is set based upon a setting of the light switch;
replicating the status to at least one additional status indicator device;
retrieving, from a configuration data store, one or more actions that correspond to at least one of the status indicator devices, wherein the actions stored in the configuration data store are configured to the user and to one or more of the status indicator devices; and
performing the retrieved actions.

9. The information handling system of claim 8 wherein the status value is selected from the group consisting of an out of office value, an on vacation value, an out on business value, an out for lunch value, an out with illness value, an in office value, and an in office but unavailable value.

10. The information handling system of claim 8 further comprising executing additional instructions that perform the action of notifying others of a status description that corresponds to the status value.

11. The information handling system of claim 8 further comprising executing additional instructions that perform the action of:
performing an action selected from the group consisting of changing an email setting, changing a voice mail setting, notifying others, shutting down devices, adjusting an HVAC system, and activating a surveillance system.

12. The information handling system of claim 8 further comprising executing additional instructions that perform the action of:
selecting the status indicator device from the group consisting of a calendar entry, an outgoing telephone message, a door lock, a window covering, an email message, and a motion sensor.

13. The information handling system of claim 8 further comprising executing additional instructions that perform the action of performing a sequence of actions corresponding to an action identifier associated with one of the status indicator devices.

14. A computer program product stored in a computer readable medium, comprising functional descriptive material that, when executed by a data processing system, causes the data processing system to perform actions that include:
generating a status value at a status indicator device selected from one or more status indicator devices, wherein at least one of the status indicator devices is a light switch and wherein the status value is set based upon a setting of the light switch;
replicating the status to at least one additional status indicator device;
retrieving, from a configuration data store, one or more actions that correspond to at least one of the status indicator devices, wherein the actions stored in the configuration data store are configured to the user and to one or more of the status indicator devices; and
performing the retrieved actions.

15. The computer program product of claim 14 wherein the status value is selected from the group consisting of an out of office value, an on vacation value, an out on business value, an out for lunch value, an out with illness value, an in office value, and an in office but unavailable value.

16. The computer program product of claim 14 further comprising notifying others of a status description that corresponds to the status value.

17. The computer program product of claim 14 further comprising additional functional descriptive material that, when executed by a data processing system, causes the data processing system to perform actions that include:
performing an action selected from the group consisting of changing an email setting, changing a voice mail setting, notifying others, shutting down devices, adjusting an HVAC system, and activating a surveillance system.

18. The computer program product of claim 14 further comprising additional functional descriptive material that, when executed by a data processing system, causes the data processing system to perform actions that include:
selecting the status indicator device from the group consisting of a calendar entry, an outgoing telephone message, a door lock, a window covering, an email message, and a motion sensor.

19. The computer program product of claim 14 further comprising additional functional descriptive material that, when executed by a data processing system, causes the data processing system to perform actions that include:
performing a sequence of actions corresponding to an action identifier associated with one of the status indicator devices.

20. The computer program product of claim 14 further comprising additional functional descriptive material that, when executed by a data processing system, causes the data processing system to perform actions that include:
responding to a trigger at one of the status indicator devices.
